(19) United States
(12) Patent Application Publication
(10) Pub. No.: US 2009/0060083 A1
(43) Pub. Date: Mar. 5, 2009

(54) RECEIVER CIRCUIT

(75) Inventors: Tae-Jin Hwang, Ichon (KR); Kun-Woo Park, Ichon (KR); Yong-Ju Kim, Ichon (KR); Hee-Woong Song, Ichon (KR); Ic-Su Oh, Ichon (KR); Hyung-Soo Kim, Ichon (KR); Hae-Rang Choi, Ichon (KR); Ji-Wang Lee, Ichon (KR)

Correspondence Address: BAKER & MCKENZIE LLP;PATENT DEPARTMENT, 2001 ROSS AVENUE, SUITE 2300, DALLAS, TX, 75201, US

(73) Assignee: HYNIX SEMICONDUCTOR, INC., Ichon (KR)

(21) Appl. No.: 12/167,077

(22) Filed: Jul. 2, 2008

(30) Foreign Application Priority Data
Sep. 4, 2007 (KR) 10-2007-0089473

(51) Int. Cl. H04L 25/34

(52) U.S. Cl. 375/286

(57) ABSTRACT

A receiver circuit includes a voltage controller configured to output an offset voltage varied according to a control code; and a multilevel receiving block configured to be controlled by the offset voltage and to amplify and output input data signal having multilevels.

### CROSS-REFERENCE TO RELATED PATENT APPLICATION

This application claims the benefit under 35 U.S.C 119(a) of Korean Application No. 10-2007-0089473, filed on Sep. 4, 2007, in the Korean Intellectual Property Office, which is incorporated herein in its entirety by reference as if set forth in full.

### BACKGROUND

1. Technical Field

The embodiments described herein relate to a semiconductor integrated circuit, and more particularly, to a receiver circuit that receives data in a semiconductor integrated circuit.

2. Related Art

In recent years, the operation speed, integration, and capacity of semiconductor integrated circuits has increased. In order to implement continuously developing semiconductor integrated circuits, various technologies not traditionally used in the past have recently been used. For example, a multilevel transmission/reception technology is widely used as an information transmission technology. Multilevel transmission/reception technology allows information transmitted through a plurality of bits of data signals to be transmitted as a data signal of one bit, in which a data signal of one bit indicates information to be transmitted through its level. That is, a data signal of one bit does not indicate only two information states, e.g., a high level state and a low level state as in the past, but indicates four or more information states, which results in reducing time loss due to utilization of a plurality of bits. Consequently, if the multilevel transmission/reception technology is used, the information transmission speed of the semiconductor integrated circuit can be increased.

In multilevel transmission/reception technology, a receiver circuit receives signals and uses offset voltages implemented by direct current (DC) voltage levels to perform a reception operation on the input signals. However, the input signals that are transmitted from a transmitter to the receiver circuit are attenuated while passing through a channel, which causes a problem in that levels of the offset voltages always become higher than the voltage levels of the input signals. In order to resolve this problem, the receiver circuit utilizes circuits to control the levels of the offset voltages. However, these circuits are vulnerable to changes in process, voltage, and temperature (PVT).

### SUMMARY

A receiver circuit capable of controlling offset voltages used to detect a multilevel signal is described herein.

According to an embodiment of the invention, a receiver circuit includes a voltage controller configured to output an offset voltage varied according to a control code; and a multilevel receiving block configured to be controlled by the offset voltages in order to amplify and output an input data signal having multilevels.

These and other features, aspects, and embodiments are described below in the section “Detailed Description.”

### BRIEF DESCRIPTION OF THE DRAWINGS

The above and other aspects, features and other advantages of the subject matter of the present disclosure will be more clearly understood from the following detailed description taken in conjunction with the accompanying drawings, in which:

FIG. 1 is a block diagram illustrating a structure of a receiver circuit according to one embodiment;

FIG. 2 is a diagram illustrating a detailed structure of a control code generating block that can be included in the circuit shown in FIG. 1;

FIG. 3 is a diagram illustrating a detailed structure of a receiver circuit that can be included in the circuit shown in FIG. 1;

FIG. 4 is a circuit diagram illustrating a detailed structure of a first sense amplifier that can be included in the circuit shown in FIG. 3;

FIG. 5A and 5B are waveform diagrams illustrating a signal level of an input data signal that can be included in the circuit shown in FIG. 1.

### DETAILED DESCRIPTION

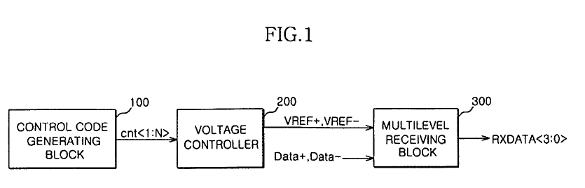

FIG. 1 is a diagram illustrating receiver circuit 101 according to an embodiment. As can be seen, the receiver circuit 101 can include a control code generating block 100, a voltage controller 200, and a multilevel receiving block 300.

The control code generating block 100 can generate a control code signal ‘cnt<1:N>.’ The control code generating block 100 can use a test signal or a signal generated according to whether or not a fuse is cut, to generate the control code signal ‘cnt<1:N>.’ The control code generating block 100 can, e.g., be implemented as a mode register set circuit.

The voltage controller 200 can output offset voltages VREF+ and VREF− that vary according to the control code signal ‘cnt<1:N>.’ The voltage controller 200 can, e.g., be implemented as a digital-to-analog converter. In general, the, e.g., digital-to-analog converter 200 can be a circuit that is configured to receive a digital signal, such as the control code signal ‘cnt<1:N>,’ and convert the digital signal into an analog signal.

Thus, it is possible to control levels of the offset voltages VREF+ and VREF− by changing logical values of the control code signal ‘cnt<1:N>,’. If the receiver circuit 11 increases or decreases the offset voltages VREF+ and VREF− according to levels of input data signals ‘Data+’ and ‘Data−’, which are changed after passing through a channel, it is possible to provide optimal offset voltages VREF+ and VREF−. As a result, it is possible to improve stability during a reception operation involving input data signals ‘Data+’ and ‘Data−’ that are implemented by multilevels.

For example, when levels of the input data signals ‘Data+’ and ‘Data−’ are decreased according to a channel status, the voltage controller 200 can lower the levels of the offset voltages VREF+ and VREF− in consideration of the decreased levels of the input data signals ‘Data+’ and ‘Data−’. Therefore, even though the levels of the input data signals ‘Data+’ and ‘Data−’ are decreased, the voltage controller 200 can receive and output data without signal distortion.

The multilevel receiving block 300 can amplify and output the multilevel input data signals ‘Data+’ and ‘Data−’ in response to the offset voltages VREF+ and VREF−. The multilevel receiving block 300 can compare the multilevel input data signals ‘Data+’ and ‘Data−’ and the offset voltages Vref+ and Vref− and amplify the multilevel input data signals ‘Data+’ and ‘Data−’, and generate an output data signal ‘RXDATA<3:0>’ having a digital logical value.

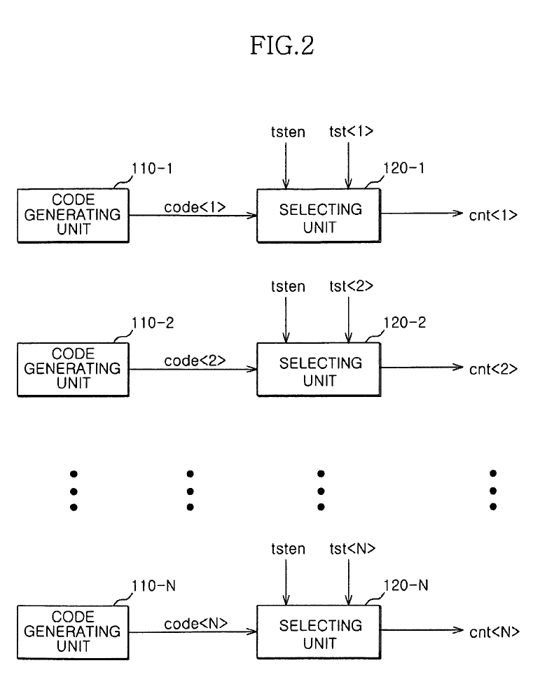

Referring to FIG. 2, the control code generating block 100 can include N code generating units 110-1 to 110-N and N selecting units 120-1 to 120-N.

Each of the N code generating units 110-1 to 110-N can include a fuse circuit or a register circuit and generate one bit of the code signal ‘code<1:N>’. Each of the N selecting units 120-1 to 120-N can selectively output one bit of the code signal ‘code<1:N>’ or one bit of a test signal ‘tst<1:N>’ as one bit of the control code signal ‘cnt<1:N>’ in response to a test enable signal ‘tsten’.

In the control code generating block 100 having the above-described structure, if a test operation is to be performed, then the test enable signal ‘tsten’ is enabled and the N bits of the test signal ‘tst<1:N>’ are output as the control code signal ‘cnt<1:N>’.

If the test operation is completed, then the test enable signal ‘tsten’ is disabled and the N bits of the code signal ‘code<1:N>’ are output as the control code signal ‘cnt<1:N>’.

In this case, each of the N-bits of the code signal ‘code<1:N>’ can have a voltage level determined according to whether a fuse, included in a fuse circuit, is cut or not, or by a signal level that is previously stored in the register circuit. As such, the control code signal ‘cnt<1:N>’ can be implemented by externally inputting a test signal at the time of a test operation.

The control code signal cnt<1:N>’ can also be implemented as a signal(s) whose level is artificially set using a fuse or a register after a test is completed. That is, the control code generating block 100 can test the predetermined levels of the offset voltages VREF+ and VREF− to generate the control code signal ‘cnt<1:N>’, which has a corresponding code value. Therefore, the offset voltages VREF+ and VREF− can have levels corresponding to the varied levels of the input data signals ‘Data+’ and ‘Data−’. As a result, the receiver circuit can operate stably.

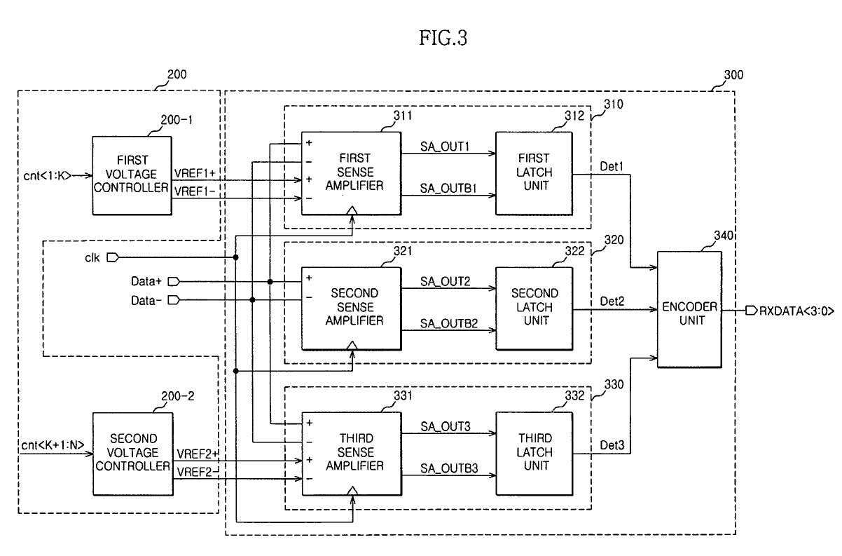

FIG. 3 is a diagram illustrating a detailed structure of the receiver circuit 101 shown in FIG. 1, which shows the structures of the voltage controller 200 and the multilevel receiving block 300. The offset voltages are implemented by the first offset voltages VREF1+ and VREF1− and the second offset voltages VREF2+ and VREF2−.

The voltage controller 200 can include a first voltage controller 200-1 and a second voltage controller 200-2. The first voltage controller 200-1 can control the first offset voltages VREF1+ and VREF1− in response to K bits ‘cnt<1:K>’ among the control code signal ‘cnt<1:N>’ and the second voltage controller 200-2 can control the second offset voltages VREF2+ and VREF2− in response to (N-K) bits ‘cnt<K+1:N>’ among the control code signal ‘cnt<1:N>’ (K is a positive integer smaller than N).

The multilevel receiving block 300 can include a high-level detecting unit 310, a medium-level detecting unit 320, a low-level detecting unit 330, and an encoder unit 340.

The high-level detecting unit 310 can use the first offset voltages VREF1+ and VREF1− to detect and amplify a signal at a first level or more among the input data signals ‘Data+’ and ‘Data−’ and output a first detection signal ‘Det1’. The high-level detecting unit 310 can include a first sense amplifier 311 and a first latch unit 312.

The first sense amplifier 311 can use the first offset voltages VREF1+ and VREF1− to amplify the input data signals ‘Data+’ and ‘Data−’ at a high level or a low level and output a first detection amplification signal pair ‘SA_OUT1’ and ‘SA_OUTB1’.

The first latch unit 312 can latch the first detection amplification signal pair ‘SA_OUT1’ and ‘SA_OUTB1’ and output the first detection signal ‘Det1’. The first latch unit 312 can be implemented by using a general S-R latch circuit.

The high-level detecting unit 310 can output the first detection signal ‘Det1’ at a high level, if the input data signals ‘Data+’ and ‘Data−’ are at a first level or more. The first level can vary depending on the first offset voltages VREF1+ and VREF1−.

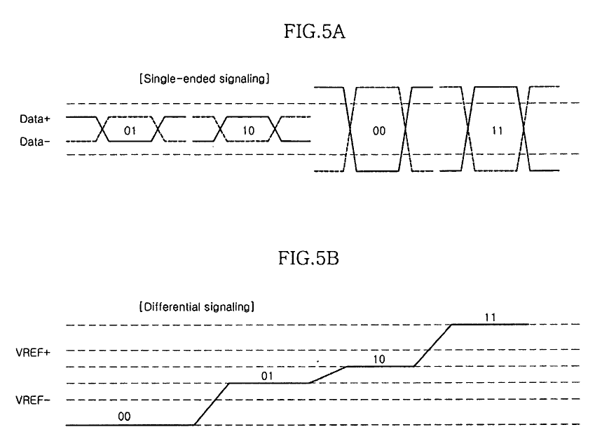

In this case, generally, the input data signals ‘Data+’ and ‘Data−’ are output from a transmitter and then input to the receiver through a channel. The input data signals ‘Data+’ and ‘Data−’ are implemented by a signal pair. The input data signals ‘Data+’ and ‘Data−’ can be discriminated as 00, 01, 10, and 11 according to levels of the input data signals ‘Data+’ and ‘Data−’ using a single-ended signaling method, as shown in FIG. 5A. Alternatively, as shown in FIG. 5B, the input data signals ‘Data+’ and ‘Data−’ can be discriminated as 00, 01, 10, and 11 using a differential signaling method. In this case, it is assumed that the first level is in a range between the level 10 and the level 11.

The medium-level detecting unit 320 can detect and amplify a signal at a second level or more among the input data signals ‘Data+’ and ‘Data−’ and output a second detection signal ‘Det2’. The medium-level detecting unit 320 can include a second sense amplifier 321 and a second latch unit 322.

The second sense amplifier 321 can amplify the input data signals ‘Data+’ and ‘Data−’ at a high level or low level and output a second detection and amplification signal pair ‘SA_OUT2’ and ‘SA_OUTB2’.

The second latch unit 322 can latch the second detection amplification signal pair ‘SA_OUT2’ and ‘SA_OUTB2’ and output the second detection signal ‘Det2’. The second latch unit 322 can be implemented by using a general S-R latch circuit.

If the input data signals ‘Data+’ and ‘Data−’ are at a second level or more, then the medium-level detecting unit 320 can output the second detection signal ‘Det2’ at a high level. In FIGS. 5A and 5B, it is assumed that the second level is in a range between the level 10 and the level 01.

The low-level detecting unit 330 can use the second offset voltages VREF2+ and VREF2− to detect and amplify a signal at a third level or more among the input data signals ‘Data+’ and ‘Data−’ and output a third detection signal ‘Det3’. The low-level detecting unit 330 can include a third sense amplifier 331 and a third latch unit 332.

The third sense amplifier 331 can use the second offset voltages VREF2+ and VREF2− to amplify the input data signals ‘Data+’ and ‘Data−’ at a high level or low level and output a third detection amplification signal pair ‘SA_OUT3’ and ‘SA_OUTB3’.

The third latch unit 332 can latch the third detection amplification signal pair ‘SA_OUT3’ and ‘SA_OUTB3’ and output the third detection signal ‘Det3’. The third latch unit 332 can, e.g., be implemented by using a general S-R latch circuit.

If the input data signals ‘Data+’ and ‘Data−’ are at a third level or more, then the low-level detecting unit 330 can output the third detection signal ‘Det3’ at a high level. The third level can vary according to the second offset voltages VREF2+ and VREF2−. In FIGS. 5A and 5B, it is assumed that the third level is in a range between the level 00 and the level 01.

The encoder unit 340 can encode the first to third detection signals ‘Det1’ to ‘Det3’ and generate the output data signal ‘RXDATA<3:0>’. The encoder unit 340 can, e.g., be implemented using a general encoder circuit.

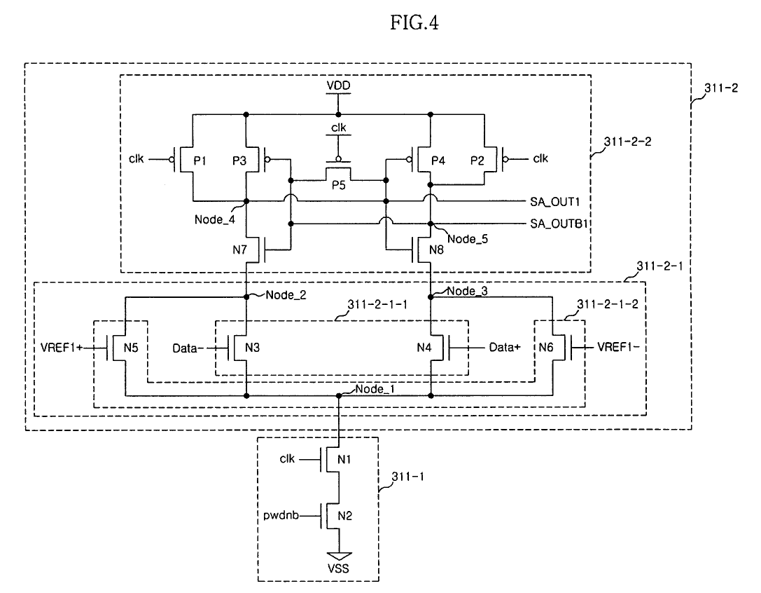

Referring to FIG. 4, the first sense amplifier 311 can include a first driving unit 311-1 and a first comparing and amplifying unit 311-2.

The first driving unit 311-1 can drive the first sense amplifier 311 in response to a clock signal ‘clk’ and a power-up signal ‘pwdnb’. The first driving unit 311-1 can include first and second NMOS transistors N1 and N2.

The first NMOS transistor N1 can include a gate that receives the clock signal ‘clk’ and a drain that is connected to a first node Node1. The second NMOS transistor N2 can include a gate that receives the power-up signal ‘pwdnb’, a drain that is connected to a source of the first NMOS transistor N1, and a source that is connected to a ground.

In this structure, when the power-up signal ‘pwdnb’ is enabled and the voltage level of the clock signal ‘clk’ is at a high level, then the first and second NMOS transistors N1 and N2 are turned on. Thus, a current path is formed in the first sense amplifier 311 and the first sense amplifier 311 operates.

The first comparing and amplifying unit 311-2 can compare and amplify the levels of the first offset voltage pair VREF1+ and VREF1− and the input data pair signals ‘Data+’ and ‘Data−’ and generate the first detection amplification signal pair ‘SA_OUT1’ and ‘SA_OUTB1’. The first comparing and amplifying unit 311-2 may include a first comparator 311-2-1 and a first amplifier 311-2-2.

The first comparator 311-2-1 can control voltage levels of signals at the second node Node_2 and the third node Node_3 according to the levels of the input data signals ‘Data+’ and ‘Data−’ and the first offset voltages VREF1+ and VREF−. The first comparator 311-2-1 can include a first data comparator 311-2-1-1 and a first offset voltage comparator 311-2-1-2.

The first data comparator 311-2-1-1 can control the voltage levels of signals at the second node Node_2 and the third node Node_3 according to the levels of the input data pair signals ‘Data+’ and ‘Data−’. The first data comparator 311-2-1-1 can include third and fourth NMOS transistors N3 and N4.

The third NMOS transistor N3 can include a gate that receives negative input data signal ‘Data−’, a drain that is connected to the second node Node_2, and a source that is connected to the first node Node_1. The fourth NMOS transistor N4 can include a gate that receives positive input data signal ‘Data+’, a drain that is connected to the third node Node_3, and a source that is connected to the first node Node_1.

The first offset voltage comparator 311-2-1-2 can control voltage levels of signals at the second node Node_2 and the third node Node_3 according to the levels of the first offset voltage pair VREF+1 and VREF−1. The first offset voltage comparator 311-2-1-2 may include fifth and sixth NMOS transistors N5 and N6.

The fifth NMOS transistor N5 can include a gate that is supplied with the positive first offset voltage VREF1+, a drain that is connected to the second node Node_2, and a source that is connected to the first node Node_1. The sixth NMOS transistor N6 can include a gate that is supplied with the negative first offset voltage VREF1−, a drain that is connected to the third node Node_3, and a source that is connected to the first node Node_1.

Under the control of the clock signal ‘clk’, the first amplifier 311-2-2 detects and amplifies the voltages at the second node Node_2 and the third node Node_3 and outputs the first detection amplification signal pair ‘SA_OUT1’ and ‘SA_OUTB1’. The first amplifier 311-2-2 includes first to fifth PMOS transistors P1 to P5 and seventh and eighth NMOS transistors N7 and N8.

The first PMOS transistor P1 can include a gate that receives the clock signal ‘clk’, a source that is supplied with an external voltage VDD, and a drain that is connected to the fourth node Node_4. The second PMOS transistor P2 can include a gate that receives the clock signal ‘clk’, a source that is supplied with the external voltage VDD, and a drain that is connected to a fifth node Node_5. The third PMOS transistor P3 can include a gate that is connected to the fifth node Node_5, a source that is supplied with the external voltage VDD, and a drain that is connected to the fourth node Node_4. The fourth PMOS transistor P4 can include a gate that is connected to the fourth node Node_4, a source that is supplied with the external voltage VDD, and a drain that is connected to the fifth node Node_5.

The fifth PMOS transistor P5 can include a gate that receives the clock signal ‘clk’, and is disposed between the fourth node Node_4 and the fifth node Node_5. The seventh NMOS transistor N7 can include a gate that is connected to the fifth node Node_5, a drain that is connected to the fourth node Node_4, and a source that is connected to the second node Node_2. The eighth NMOS transistor N8 can include a gate that is connected to the fourth node Node_4, a drain that is connected to the fifth node Node_5, and a source that is connected to the third node Node_3.

In the first comparing and amplifying unit 311-2 having the above-described structure, if a voltage level of the clock signal ‘clk’ is at a high level, the first sense amplifier 311 is not driven. In this case, since the first and second PMOS transistors P1 and P2 and the fifth PMOS transistor P5 are turned on, the first detection amplification signal pair ‘SA_OUT1’ and ‘SA_OUTB1’ maintains a level of the external voltage VDD. When the voltage level of the clock signal ‘clk’ is at a high level, the first and second PMOS transistor P1 and P2 and the fifth PMOS transistor P5 are turned off, and thus the first comparing and amplifying unit 311-2 is driven.

When the input data signals ‘Data+’ and ‘Data−’ that have levels lower than those of the first offset voltages VREF1+ and VREF1− are input, the voltage levels of the signals at the second node Node_2 and the third node Node_3 become a low level. In this case, the lower level means that absolute values of the levels of the input data signals ‘Data+’ and ‘Data−’ are smaller than absolute values of the levels of the first offset voltages VREF1+ and VREF1−.

When the input data signals ‘Data+’ and ‘Data−’ that have levels higher than those of the first offset voltages VREF1+ and VREF1− are input, the voltage level of the signal at the second node Node_2 becomes a high level, and the voltage level of the signal at the third node Node_3 becomes a low level. Therefore, a voltage level of the positive first detection amplification signal ‘SA_OUT1’ output from the fourth node Node_4 transitions to a low level, and a voltage level of the negative first detection amplification signal ‘SA_OUTB1’ output from the fifth node Node_5 becomes a high level. Meanwhile, when the input data signals ‘Data+’ and ‘Data−’ that have levels lower than those of the first offset voltages VREF1+ and VREF1− are input, the voltage level of the signal at the second node Node_2 transitions to a low level and the voltage level of the signal at the third node Node_3 becomes a high level. As a result, the voltage levels of the positive first detection amplification signal ‘SA_OUT1’ and the negative first detection amplification signal ‘SA_OUTB1’ transitions to a high level and a low level, respectively.

That is, if the first offset voltages VREF1+ and VREF1− are at a first level, the first sense amplifier 311 outputs a low-level signal when the input data signals ‘Data+’ and ‘Data−’ are at a level higher than the first level and the first sense amplifier 311 outputs a high-level signal when the input data signals ‘Data+’ and ‘Data−’ are at a level lower than the first level.

The second sense amplifier 321 may be implemented to have the same structure as the first sense amplifier 311 except that the first offset voltage comparator 311-2-1-2 may not be included. That is, the second sense amplifier 221 can include a second driving unit and a second comparing and amplifying unit. The second driving unit drives the second sense amplifier 321 under the control of the clock signal ‘clk’. The second comparing and amplifying unit compares and amplifies the levels of the input data signals ‘Data+’ and ‘Data−’ and generates the second detection amplification signal pair ‘SA_OUT2’ and ‘SA_OUTB2’.

The third sense amplifier 331 may be implemented to have a structure that is similar to that of the first sense amplifier 311. That is, the third sense amplifier 331 can include a third driving unit and a third comparing and amplifying unit. The third driving unit can drive the third sense amplifier 331 under the control of the clock signal ‘clk’. The third comparing and amplifying unit compares and amplifies levels of the input data signals ‘Data+’ and ‘Data−’ and the second offset voltages VREF2+ and VREF2− and generates the third detection amplification signal pair ‘SA_OUT3’ and ‘SA_OUTB3’.

Hereinafter, the operation of the receiver circuit according to one embodiment will be described with reference to FIGS. 1 to 3.

If the clock signal ‘clk’ is enabled and the power-up signal ‘pwdnb’ is enabled, the first to third sense amplifiers 311, 321, and 331 are driven.

The voltage controller 200 outputs the first offset voltages VREF1+ and VREF1− and the second offset voltages VREF2+ and VREF2− that have levels corresponding to the logical value of the control code signal ‘cnt<1:N>’. Then, the first sense amplifier 311 and the third sense amplifier 331 are supplied with the first offset voltages VREF1+ and VREF1− and the second offset voltages VREF2+ and VREF2− and perform an amplifying operation on the input data signals ‘Data+’ and ‘Data−’, respectively.

The third sense amplifier 331 is supplied with the first offset voltages VREF1+ and VREF1− instead of the second offset voltages VREF2+ and VREF2−. At this time, the third sense amplifier 331 may be supplied with the first offset voltages VREF1+ and VREF1− whose polarities are changed.

As shown in FIGS. 5A and 5B, the levels of the input data pair signals ‘Data+’ and ‘Data−’ can be represented by four levels, that is, 00, 01, 10, and 11. For example, the high-level detecting unit 310 is supplied with the first offset voltages VREF1+ and VREF1− that have the first level in a range between the level 10 and the level 11. When the levels 00, 01, 10, and 11 are represented by analog voltages, if the levels are −2V, −1V, 1V, and 2V, respectively, the first level is set to 1.5V. If the input data signals ‘Data+’ and ‘Data−’ whose levels are 1.5V or more are input, the high-level detecting unit 310 outputs a low-level signal, and if the signals whose levels are lower than 1.5V are input, the high-level detecting unit 310 outputs a high-level signal.

The medium-level detecting unit 320 is not supplied with the offset voltages and performs an amplification operation according to the levels of the input data signals ‘Data+’ and ‘Data−’. Therefore, when the levels of the input data signals ‘Data+’ and ‘Data−’ are 00 and 01, the medium-level detecting unit 320 outputs a low-level signal, and when the levels of the input data signals ‘Data+’ and ‘Data−’ are 10 and 11, the medium-level detecting unit 320 outputs a high-level signal.

The low-level detecting unit 330 may set the third voltage level to —1.5V. When the levels of the input data signals ‘Data+’ and ‘Data−’ are higher than −1.5V, the low-level detecting unit 330 outputs a low-level signal, and when the levels of the input data signals ‘Data+’ and ‘Data−’ are lower than −1.5V, the low-level detecting unit 330 outputs a high-level signal. Therefore, if the levels of the input data signals ‘Data+’ and ‘Data−’ are 11, 10, and 01, the low-level detecting unit 330 outputs a low-level signal, but if the levels of the input data signals ‘Data+’ and ‘Data−’ are 00, the low-level detecting unit 330 outputs a high-level signal.

For example, if the levels of the input data signals ‘Data+’ and ‘Data−’ are 11, the voltage levels of the input data signals ‘Data+’ and ‘Data−’ are 2V. Thus, the high-level detecting unit 310 outputs the first detection signal ‘Det1’ at a high level, the medium-level detecting unit 320 outputs the second detection signal ‘Det2’ at a high level, and the low-level detecting unit 330 outputs the third detection signal ‘Det3’ at a high level. The encoder unit 340 encodes the first to third detection signals ‘Det1’ to ‘Det3’ at high levels and outputs signals having a logical value of 11.

Further, if the levels of the input data signals ‘Data+’ and ‘Data−’ are 10, the voltage levels of the input data signals ‘Data+’ and ‘Data−’ are 1V. Thus, the high-level detecting unit 310 outputs the first detection signal ‘Det1’ at a low level, the medium-level detecting unit 320 outputs the second detection signal ‘Det2’ at a high level, and the low-level detecting unit 330 outputs the third detection signal ‘Det3’ at a high level. The encoder unit 340 encodes the first to third detection signals ‘Det1’ to ‘Det3’ and outputs signals having a logical value of 10.

Thus, the receiver circuit can perform a predetermined operation even when the levels of the input data signals ‘Data+’ and ‘Data−’ are 01 and 00.

According to one embodiment, when the voltage levels of the input data signals ‘Data+’ and ‘Data−’ are decreased and a signal that has a logical value of 11 and a voltage level of 1.5V is input to the receiver circuit, the receiver circuit uses the voltage controller 200 implemented by the digital-to-analog converter to decrease the levels of the first offset voltages VREF1+ and VREF1− from 1.5V in the related art to 1.2V, which prevents an erroneous operation when the high-level detecting unit 310 outputs a low-level signal.

The receiver circuit can precisely control the offset voltages and be applied even in various channel statuses. The receiver circuit may be applied to various fields, such as a memory, a CPU, and an ASIC. The receiver circuit can detect the signals on the basis of three levels according to multilevels, but the number of levels is not limited.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A receiver circuit comprising:
a voltage controller configured to output an offset voltage varied according to a control code; and
a multilevel receiving block configured to be controlled by the offset voltage in order to amplify and output an input data signal having multilevels.

2. The receiver circuit of claim 1,
wherein the voltage controller is a digital-to-analog converter.

3. The receiver circuit of claim 1,
wherein the multilevel receiving block includes:
a high-level detecting unit configured to use the offset voltage to detect and amplify a signal at a first level or more among the input data signal and to output a first detection signal;
a medium-level detecting unit configured to detect and amplify a signal at a second level or more among the input data signal and to output a second detection signal;
a low-level detecting unit configured to use the offset voltage to detect and amplify a signal at a third level or more among the input data signal and to output a third detection signal; and
an encoder unit configured to encode the first to third detection signals and to generate output data, and
wherein the first level is higher than the second level and the second level is higher than the third level.

4. The receiver circuit of claim 3,
wherein the high-level detecting unit includes:
a first sense amplifier configured to use the offset voltage to amplify the input data signal and to output a first detection amplification signal; and
a first latch unit configured to latch the first detection amplification signal and to output the first detection signal.

5. The receiver circuit of claim 4,
wherein the first sense amplifier includes:
a first driving unit configured to drive the first sense amplifier in response to a clock signal; and
a first comparing and amplifying unit configured to compare and amplify levels of the input data signal and the offset voltage and to generate the first detection amplification signal.

6. The receiver circuit of claim 5,
wherein the first comparing and amplifying unit includes:
a first comparator configured to control voltage levels of signals at first and second nodes according to the levels of the input data signal and the offset voltage; and
a first amplifier configured to detect and amplify the voltages at the first and second nodes and to generate the first detection amplification signal.

7. The receiver circuit of claim 6,
wherein the first comparator includes:
a first data comparator configured to control the voltage levels of the signals at the first and second nodes according to the levels of the input data signal; and
a first offset voltage comparator configured to control the voltages at the first and second nodes according to the level of the offset voltage.

8. The receiver circuit of claim 3,
wherein the medium-level detecting unit includes:
a second sense amplifier configured to amplify the input data signal and to output a second detection amplification signal; and
a second latch unit configured to latch the second detection amplification signal and to output the second detection signal.

9. The receiver circuit of claim 3,
wherein the low-level detecting unit includes:
a third sense amplifier configured to use the offset voltage to amplify the input data signal and to output a third detection amplification signal; and
a third latch unit configured to latch the third detection amplification signal and to output the third detection signal.

10. The receiver circuit of claim 1, further comprising:
a control code generating block configured to generate the control code,
wherein the control code generating block includes:
a plurality of code generating units, each of which includes a fuse circuit or a register circuit and generates a bit of a code signal; and
a plurality of selecting units, each of which outputs each bit of the code signal or each bit of a test signal as the corresponding control code in response to a test enable signal.
